(19) United States
(12) Patent Application Publication
(10) Pub. No.: US 2014/0199972 A1
(43) Pub. Date: Jul. 17, 2014

(54) CELLULAR PHONE PAIRED WITH WIRELESS COMMUNICATION DEVICE VIA NEAR FIELD COMMUNICATION

(71) Applicant: NEC Casino Mobile Communications, Ltd., Kanagawa-ken (JP)

(72) Inventor: Daisuke EJIMA, Kodama-gun (JP)

(73) Assignee: NEC CASIO MOBILE COMMUNICATIONS, LTD., Kanagawa-ken (JP)

(21) Appl. No.: 14/153,589

(22) Filed: Jan. 13, 2014

(30) Foreign Application Priority Data
Jan. 16, 2013 (JP) 2013-005260

(51) Int. Cl. H04W 4/00; H04W 12/06

(52) U.S. Cl. CPC H04W 4/008; H04W 12/06
USPC 455/411; 455/41.2

(57) ABSTRACT

A cellular phone is shared by a plurality of users with a wireless communication device including a SIM card storing user identification dedicated to each user. Each user simply makes touch access to the cellular phone with the wireless communication device, and therefore the wireless communication device transmits user identification to the cellular phone via a near field communication. The cellular phone authenticates user identification so as to establish a high-speed wireless communication with the wireless communication device. Thus, the user is allowed to log in the cellular phone paired with the wireless communication device. Additionally, the wireless communication device may include an access release key which is operated by each user to log out the cellular phone.

### BACKGROUND OF THE INVENTION

1. Field of the Invention

The present invention relates to a cellular phone which is paired with a wireless communication device via a near field communication when accessing a wireless communication network with user identification.

The present application claims priority on Japanese Patent Application No. 2013-5260 filed Jan. 16, 2013, the entire content of which is incorporated herein by reference.

2. Description of the Related Art

Recently, multifunction cellular phones such as smart phones (hereinafter, simply referred to as cellular phones) have become dominant in telecommunication markets. Due to economical reasons, a single cellular phone is not necessarily possessed by a single user but shared with multiple users via sharing services, which have been gradually implemented in telecommunication services.

Cellular phones are detachably equipped with SIM (i.e. Subscriber Identity Module) cards recording user identifications unique to users. Cellular phones specify telephone numbers and contractual terms from user identifications which are read from SIM cards, thus providing users with various services such as voice communication and data communication.

It is possible to develop various types of sharing methods which may allow a plurality of users to share a single cellular phone. For example, a plurality of users is individually provided with SIM cards recording user identifications in advance, and then each user needs to insert an individual SIM card into a cellular phone to implement telecommunication services. This sharing method is inconvenient because it is burdensome for each user to insert an individual SIM card into a cellular phone every time using it.

Another sharing method can be developed to alleviate burdens in inserting individual SIM cards into a single cellular phone. A plurality of users is individually assigned an ID and a password in connection with a single cellular phone. Each user logs in a cellular phone with an ID and a password, and then the cellular phone reads user identification from a server via a communication network dedicated thereto, thus implementing telecommunication services.

Patent Literature Document 1 discloses a cellular phone wirelessly paired with an external device (e.g. a card case) holding a SIM card. Herein, the external device holding a SIM card wirelessly transmits a personal identification to a cellular phone to implement telecommunication services via Bluetooth (a trademark), i.e. a wirelessly established near field communication.

The aforementioned sharing method, in which each user logs in a cellular phone with an ID and a password so as to read user identification from a server, may suffer from the following problems.

This sharing method may work on the precondition of logging in a cellular phone with login information (e.g. an ID and a password for each user), which should be kept in confidentiality. It may involve a risk of divulging login information by an outsider or a stranger who may visually scan login information when each user inputs login information with a cellular phone. It is burdensome for each user to input login information every time using a cellular phone. This may degrade convenience of sharing services.

In the aforementioned sharing method, it is necessary for a cellular phone inputting login information to connect with a cellular phone network so as to retrieve user identification. For this reason, a SIM card recording identifications of multiple users needs to be installed in a cellular phone in advance. Herein, a SIM card is used to record an identification of an owner of a cellular phone. The owner of a cellular phone needs to lend the cellular phone including a SIM card to another user. This may involve a security risk of the owner of a cellular phone. Additionally, it is impossible for a cellular phone to notify one user of incoming calls and emails when another user logs in the cellular phone.

Patent Literature Document 1 discloses the technology in which an external device holding a SIM card wirelessly transmits personal identification to a cellular phone, thus implementing telecommunication services with the cellular phone. This technology suffers from the following problems.

When a cellular phone is wirelessly paired with an external device holding a SIM card via Bluetooth, it is necessary for the external device to authenticate each user by use of a PIN (i.e. Personal Identification Number); however, this may involve a security risk. When one user is switched to another user, it is necessary for each user to temporarily disestablish paring between a cellular phone and an external device, and then each user needs to reestablish paring between them with another SIM card. This is burdensome for a cellular phone to smoothly switch one user to another user. In short, it is difficult for this technology to achieve a sharing method among multiple users with a cellular phone.

### CITATION LIST

### Patent Literature Document

Patent Literature Document 1: Japanese Patent Application Publication No. 2003-244290

### SUMMARY OF THE INVENTION

It is an object of the present invention to provide a cellular phone which is paired with a wireless communication device authenticating each user so as to smoothly switch one user to another user, thus implementing telecommunication services for each user.

A first aspect of the present invention is directed to a cellular phone including a touch access part which receives user identification via near field communication; a login authentication part which specifies a user by way of an authentication process based on the user identification; and a paring part which establishes a high-speed wireless communication with an external device dedicated to the specified user.

A second aspect of the present invention is directed to a wireless communication device including a user information recording part which records user identification unique to each user; a touch access part which transmits the user identification to a cellular phone via near field communication; a paring part which establishes a high-speed wireless communication with the cellular phone; and a line communication part which wirelessly communicates with a cellular phone network in connection with the cellular phone.

A third aspect of the present invention is directed to a wireless communication system including a cellular phone and a wireless communication device. The cellular phone further includes a first touch access part which receives user identification via near field communication, a login authentication part which specifies a user by way of an authentication process based on the user identification, and a first paring part which establishes a high-speed wireless communication with the wireless communication device dedicated to the specified user. The wireless communication device further includes a user information recording part which records user identification unique to each user, a second touch access part which transmits the user identification to the cellular phone via near field communication, a second paring part which establishes a high-speed wireless communication with the cellular phone, and a line communication part which wirelessly communicates with a cellular phone network in connection with the cellular phone.

A fourth aspect of the present invention is directed to a wireless communication method including: receiving user identification from an external device via near field communication; specifying each user by way of an authentication process based on the user identification; and establishing a high-speed wireless communication with the external device dedicated to the specified user.

The present invention is applied to a sharing method in which a plurality of users shares a single cellular phone by use of their identifications. The present invention is characterized by introducing a wireless communication device, including a user identification recording part (e.g. a SIM card) storing user identification unique to each user, which is wirelessly paired with a cellular phone via near field communication. Specifically, the user of a wireless communication device simply makes touch access to a cellular phone to establish a high-speed wireless communication therebetween; hence, the user is allowed to log in the cellular phone paired with the wireless communication device. Thus, the present embodiment improves security and convenience in sharing a single cellular phone with a plurality of users.

### BRIEF DESCRIPTION OF THE DRAWINGS

These and other objects, aspects, and embodiments of the present invention will be described in more detail with reference to the following drawings.

FIG. 1 is a block diagram showing the minimum configuration of a cellular phone according to the preferred embodiment of the present invention.

FIG. 2 is a block diagram showing a wireless communication system including a wireless communication device paired with a cellular phone in connection with a cellular phone network.

FIG. 3 is a perspective view with an enlarged view of an access release key attached to the wireless communication device.

FIG. 4 is a sequence diagram used to explain a first flow of processing exerted between the cellular phone and the wireless communication device in connection with the cellular phone network.

FIG. 5 is a sequence diagram used to explain a second flow of processing exerted between the cellular phone and the wireless communication device in connection with the cellular phone network.

FIG. 6 is a system diagram showing a modified example of the wireless communication system using the cellular phone and the wireless communication device.

### DESCRIPTION OF THE PREFERRED EMBODIMENT

The present invention will be described in further detail by way of examples with reference to the accompanying drawings.

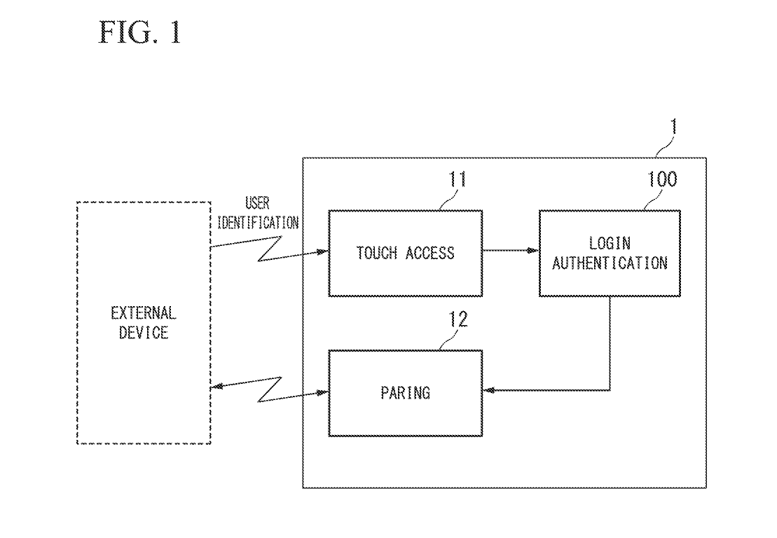

FIG. 1 is a block diagram showing the minimum configuration of a cellular phone 1 according to the preferred embodiment of the present invention. The cellular phone 1 includes a touch access part 11 for receiving user identification from an external device via near field communication, a login authentication part 100 for authenticating and specifying each user based on user identification, and a paring part 12 for establishing high-speed wireless communication with the external device upon specifying each user.

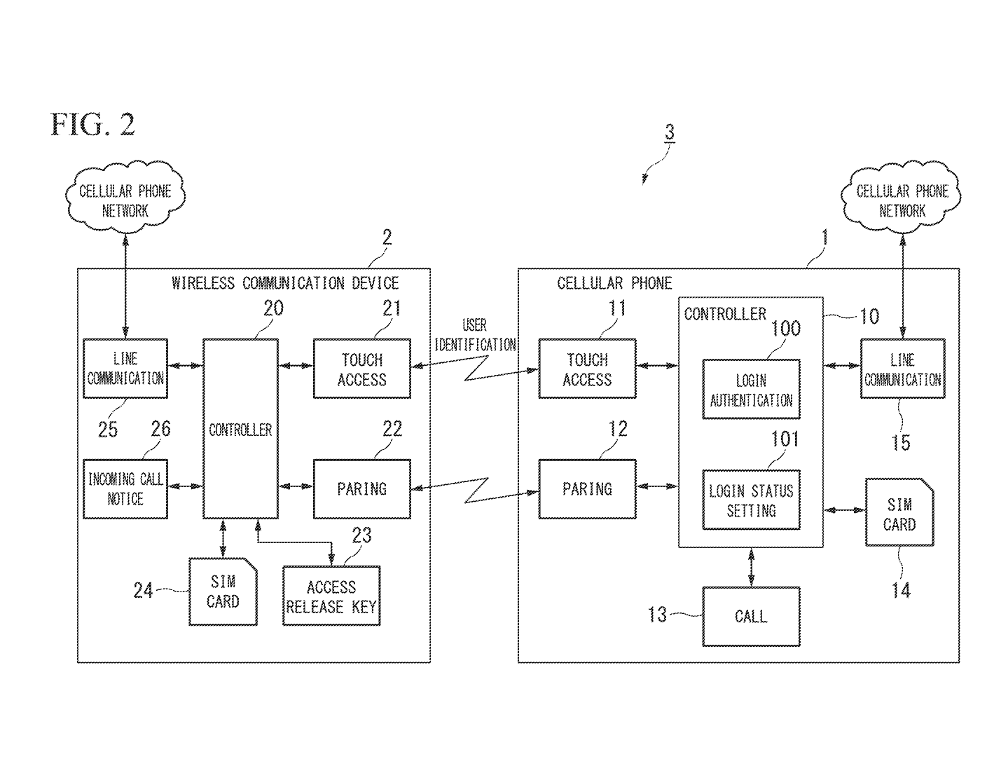

FIG. 2 is a block diagram showing a wireless communication system 3 including a wireless communication device 2 paired with the cellular phone 1. The cellular phone 1 is a smart phone which provides various services (e.g. voice communication and data communication) when being connected to cellular phone networks, e.g. communication networks based on telecommunication standards such as 3G (i.e. 3rd generation mobile phones) and LTE (Long Term Evolution). The cellular phone 1 has a login function to implement sharing services with a plurality of users. That is, each user needs to carry out a login process (or an authentication process) to access a cellular phone communication network with the cellular phone 1. Upon specifying each user in the authentication process, the cellular phone 1 adopts a system environment dedicated to each user, thus declaring a “login complete status”. In the login complete status, the cellular phone 1 carries out processing to implement various services (e.g. voice communication, transmission and reception of emails, and cloud services) in a system environment dedicated to each user.

As shown in FIG. 2, the cellular phone 1 includes a controller 10, a touch access part 11, a paring part 12, a call part 13, a SIM card 14, and a line communication part 15. The controller 10 is configured of a CPU which controls functions, process information, and perform calculations. The controller 10 reads programs stored in a storage device (not shown). Specifically, the controller 10 implements various functions with a login authentication part 100 and a login status setting part 101.

The login authentication part 100 receives user identification to carry out an authentication process, thus specifying each user. Herein, the user identification includes various pieces of information such as a telephone number and contractual terms, wherein cellular phone communication service companies (i.e. carriers) may issue user identification for each contractor. The user identification is recorded in the SIM card 14. In the present embodiment, the login authentication part 100 receives user identification from an external device (i.e. the wireless communication device 2) via the touch access part 11.

When the login authentication part 100 successfully specifies each user, the login status setting part 101 declares the login complete status of the cellular phone 1 adopting a system environment dedicated to each user. In the login complete status, each user performing a login process (or an authentication process) is allowed to use the cellular phone 1 in the system environment dedicated to each user. In this connection, a system environment for each user is independently controlled and stored in the cellular phone 1; hence, this prevents each user from acquiring usages and communication histories of other users.

Upon receiving a logout notice via the paring part 12 in the login condition of each user, the login status setting part 101 terminates the login complete status and carries out a process to set the cellular phone 1 to a “non-login status”. The non-login status indicates that none of users logs in the cellular phone 1. In the non-login status, the cellular phone 1 disallows users to implement various services, and therefore the cellular phone 1 is allowed to simply accept login authentication.

The touch access part 11 is a communication module which establishes a near field communication with an external device (e.g. the wireless communication device 2) so as to receive or transmit information. Specifically, the touch access part 11 is a communication module which is able to perform wireless communication within a communication field of several centimeters in accordance with near field communication standards using high frequency bands (e.g. 13.56 MHz), such as NFC (Near Field Communication) using electromagnetic induction coupling and FeliCa (known as a noncontact IC card technology). By lightly touching an external device with the cellular phone 1 including the touch access part 11, it is possible for the cellular phone 1 to receive or transmit data with the external device. This operation will be referred to as “touch access”. In the present embodiment, the touch access part 11 receives user identification from the external device via near field communication.

The paring part 12 is a communication module which is able to establish a high-speed wireless communication (i.e. paring) with an external device (i.e. the wireless communication device 2) in accordance with high-speed wireless communication standards (e.g. Bluetooth) having broader communication fields than wireless communication standards employed by the touch access part 11, and therefore the paring part 12 can receive and transmit data with the external device. The paring part 12 authenticate each user based on user identification which is retrieved from the external device via the touch access part 11, wherein the paring part 12 is wirelessly paired with the external device upon specifying each user.

In order to secure paring between the paring part 12 and a specific external device, both the paring part 12 and the specific external device need to mutually adopt communication setting information. After the authentication process, the paring part 12 needs to immediately receive or transmit the communication setting information (which is required to establish paring between the paring part 12 and the external device) via the touch access part 11. In the non-login status of the cellular phone 1, the paring part 12 disconnects a high-speed wireless communication which has been established with the external device.

The call part 13 is a module implementing a call function serving as the cellular phone 1. For example, the call part 13 includes an audio microphone and a speaker. The SIM card 14 is a recording medium which records user identification for each user and is issued by a certain carrier in advance. In the present embodiment, the cellular phone 1 is equipped with a SIM card socket which receives the SIM card 14 inserted by each user.

The cellular phone 1 of the present embodiment is shared by a plurality of users. As shown in FIG. 2, the cellular phone 1 have already included the SIM card 14 therein. The SIM card 14 stores a user identification regarding the owner of the cellular phone 1. That is, the owner is authorized to use the cellular phone 1 based on the owner's user identification, recorded in the SIM card 14, without accessing the external device (i.e. the wireless communication device 2).

The line communication part 15 is a communication module which is connected to the cellular phone network to receive or transmit various pieces of information. Thus, the cellular phone 1 is connected to the cellular phone network via the line communication part 15 to provide each user with various telecommunication services such as voice communication, reception and transmission of emails, and cloud services.

The cellular phone 1 of the present embodiment may be further equipped with other functions other than the foregoing functions shown in FIG. 2. For example, the cellular phone 1 may be equipped with a GPS (i.e. Global Positioning System) interlocked with map searching services, a touch-panel display, a camera, and various sensor.

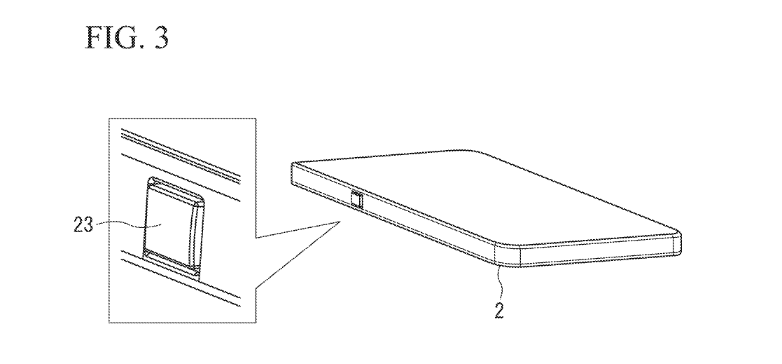

Next, the wireless communication device 2 included in the wireless communication system 3 will be described with reference to FIGS. 2 and 3.

The wireless communication device 3 including a SIM card 24 which stores user identification receives or transmits data with the cellular phone 1 via certain wireless communication standards. Each of the users sharing the cellular phone 1 needs to possess the wireless communication device 2 including the SIM card 24 which is issued for each user. Each of the users sharing the cellular phone 1 is individually allowed to use the cellular phone 1 via paring with the wireless communication device 2 including the SIM card 24 for each user. In this connection, the wireless communication device 2 has connectivity to the cellular phone network but does not have other telecommunication functions such as voice communication, email creation, and browsing.

As shown in FIG. 2, the wireless communication device 2 includes a controller 20, a touch access part 21, a paring part 22, an access release key 23, a SIM card 24, a line communication part 25, and an incoming call notice part 26. The controller 20 is configured of a CPU which is equivalent to the controller 10 of the cellular phone 1. The controller 20 controls various functions and performs calculations. The touch access part 21 is equivalent to the touch access part 11 of the cellular phone 1. The touch access part 21 is a communication module which establishes a near field communication with the cellular phone 1. Through touch access with the cellular phone 1, the touch access part 21 of the wireless communication device 2 wirelessly transmits the user identification of the SIM card 24 to the cellular phone 1. Each user holding the wireless communication device 2 is allowed to log in the cellular phone 1 via touch access since the login authentication part 100 inputs the user identification to authenticate each user.

The paring part 22 is equivalent to the paring part 12 of the cellular phone 1. The paring part 22 establishes a high-speed wireless communication (e.g. Bluetooth) with the paring part 12 so as to receive or transmit data with the cellular phone 1. When each user logs in the cellular phone 1 via touch access with the wireless communication device 2, the paring part 22 immediately starts paring with the paring part 12 of the cellular phone 1.

FIG. 3 is a perspective view with an enlarged view of an access release key 23 attached to the wireless communication device 2. The access release key 23 is a hardware key which is depressed when each user terminates the usage of the cellular phone 1 paired with the wireless communication device 2. When each user depresses the access release key 23 of the wireless communication device 2, the paring part 22 transmits a logout notice to the cellular phone 1. Upon receiving the logout notice via the paring part 12, the login status setting part 101 of the cellular phone 1 terminates a system environment dedicated to each user, thus setting the cellular phone 1 to a non-login status. This process disconnects a high-speed wireless communication established between the paring part 12 and the paring part 22.

The SIM card 24 is an example of user identification storage media. Similar to the SIM card 14 installed in the cellular phone 1, the SIM card 24 serves as a recording medium recording user identification issued by a carrier with respect to each user. Specifically, the SIM card 24 stores a user identification regarding a certain user who shares the cellular phone 1 except for the owner of the cellular phone 1. Similar to the cellular phone 1 including the SIM card 14, the wireless communication device 2 is equipped with a SIM card socket allowing for insertion of the SIM card 24.

The line communication part 25 is a communication module which receives or transmits data in connection with the cellular phone network. The wireless communication device 2 including the SIM card 24 may receive or transmit data, which is needed for voice communication and cloud services, via the line communication part 25 in connection with the cellular phone network. However, the wireless communication device 2 does not install a voice communication function and a browsing function needed for cloud services therein. That is, the wireless communication device 2 serves as the intermediation associated to connection between the cellular phone 1 and the cellular phone network. Specifically, the paring part 22 receives data from the cellular phone network via the line communication part 25 so as to transmit the received data to the cellular phone 1, while the parting part 22 receives data from the cellular phone 1 so as to transmit the received data to the cellular phone network via the line communication part 25.

Similar to conventional cellular phones, the wireless communication device 2 is normally connectible to the cellular phone network. Additionally, upon receiving an incoming call relating to a telephone number recorded in the SIM card 24, the wireless communication device 2 is able to receive an incoming call signal destined to the user of the SIM card 24 via the line communication part 25.

The incoming call notice part 26 notifies the user of reception of an incoming call signal while receiving the incoming call signal via the line communication part 25. Herein, an “incoming call signal” is used to notify calling destined to each user from the cellular phone network (e.g. a base station) when the other person calls each user. Upon receiving an incoming call signal, the incoming call notice part 26 reproduces an incoming call sound or vibrates the wireless communication device 2 so as to notify each user of reception of the incoming call signal.

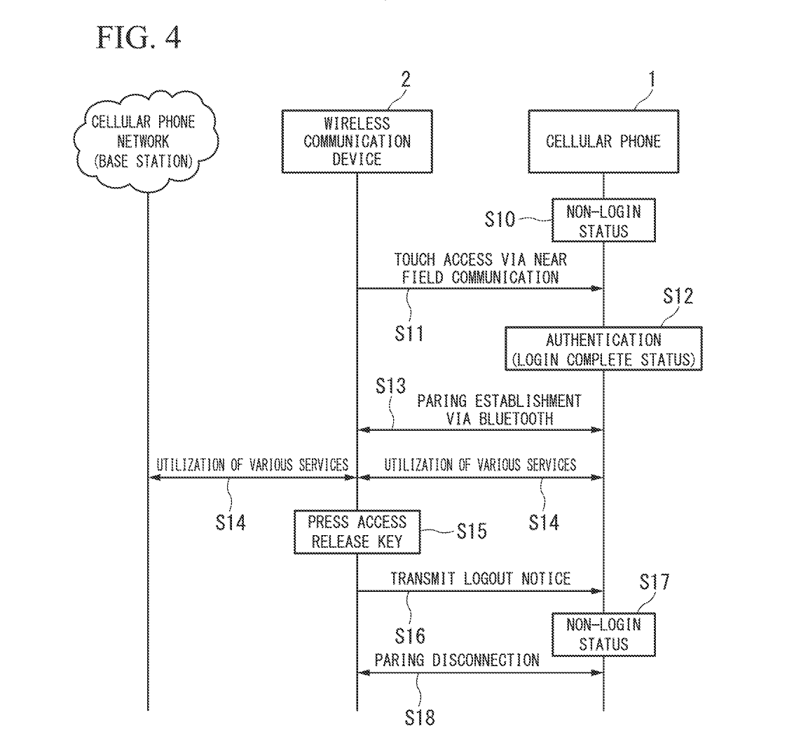

FIG. 4 is a sequence diagram used to explain a first flow of processing exerted between the cellular phone 1 and the wireless communication device 2 in connection with the cellular phone network.

Next a flow of processing exerted on the wireless communication system, including the cellular phone 1 and the wireless communication device 2, will be described below. First, a flow of a user's operation on the cellular phone 1 will be described with reference to FIG. 4.

At first, the cellular phone 1 is set to the “non-login status” (step S10). In this state, the user of the wireless communication device 2 does not log in the cellular phone 1, and therefore the user is unable to use the cellular phone 1. Next, the user makes “touch access” to the wireless communication device 2 to start using the cellular phone 1 (step S11). Specifically, the controller 20 reads user identification from the SIM card 24 installed in the wireless communication device 2 so as to send the user identification to the touch access part 21. Subsequently, the touch access part 21 transmits the user identification to the touch access part 11 of the cellular phone 1.

In the cellular phone 1, the controller 10 (i.e. the login authentication part 100) carries out an authentication process based on the user identification received via the touch access part 11. In the authentication process, the login authentication part 100 refers to a login ID and a password described in the user identification for each user. Subsequently, the login authentication part 100 determines whether or not a pair of the login ID and the password matches with any of login IDs and passwords which are registered with the cellular phone 1 in advance with respect to a plurality of users sharing the cellular phone 1. When the login authentication part 100 successfully specifies the user who accesses the cellular phone 1 by way of the authentication process, the login status setting part 101 adopts a system environment unique to the user so as to set the cellular phone 1 to the “login complete status” (step S12).

Upon completion of the authentication process, the touch access part 11 of the cellular phone 1 and the touch access part 21 of the wireless communication device 2 mutually exchange various pieces of information needed to establish paring therebetween. When the cellular phone 1 is set to the login complete status upon successfully authenticating the user of the wireless communication device 2 accessing the cellular phone 1, the paring part 12 and the paring part 22 establishes a high-speed wireless communication (i.e. paring) via Bluetooth (step S13).

Thus, the user is allowed to use voice communication, reception and transmission of emails, and cloud services with the cellular phone 1 (step S14). Herein, the cellular phone 1 receives and transmits data in connection with the cellular phone network by way of the wireless communication device 2. Specifically, the controller 20 of the wireless communication device 2 receives data from the cellular phone 1 via the paring part 22 so as to transmit the received data to the cellular phone network via the line communication part 25. Additionally, the controller 20 receives data from the cellular phone network via the line communication part 25 so as to transmit the received data to the cellular phone 1 via the paring part 22.

To terminate the usage of the cellular phone 1, the user depresses the access release key 23 attached to the wireless communication device 2 (step S15). Upon detection the access release key 23 being depressed, the controller 20 transmits a logout notice to the cellular phone 1 via the paring part 22 (step S16). Upon receiving the logout notice via the paring part 12, the controller 10 (i.e. the login status setting part 101) of the cellular phone 1 initializes the system environment dedicated to the user (e.g. eliminating user's access histories) so as to terminate the login complete status, thus setting the cellular phone 1 to the “non-login status” (step S17). Subsequently, the cellular phone 1 paired with the wireless communication device 2 disconnects a high-speed wireless communication established between the paring parts 12 and 22 (step S18). In short, when the user depresses the access release key 23, the cellular phone 1 paired with the wireless communication device 2 restores the previous state before the user logs in the cellular phone 1.

The sequence diagram of FIG. 4 is explained on the precondition that the cellular phone 1 is initially set to the non-login status (step S10); but this is not a restriction. For example, when one user makes “new” touch access to the cellular phone 1 on the condition that the cellular phone 1 is currently being set to the login complete status with the other user, the login status setting part 101 changes the login complete status so as to temporarily set the non-login status with the cellular phone 1. Subsequently, the login status setting part 101 immediately adopts a system environment dedicated to one user specified via new touch access, thus newly setting the login complete status with the cellular phone 1

In step S14, the cellular phone 1 accesses the wireless communication device 2 to communicate with the cellular phone network via the line communication part 25, thus providing various services to each user. However, the cellular phone 1 may directly communicate with the cellular phone network via the line communication part 15 depending on conditions.

As described above, the cellular phone 1 paired with the wireless communication device 2 provides sharing services with each user. The present embodiment is very convenient because each user is allowed to log in the cellular phone 1 by simply making touch access to the cellular phone 1 with the wireless communication device 2.

The present embodiment provides a unique sharing method adapted to a plurality of users simply holding their SIM cards. Thus, it is possible for each user to log in the cellular phone 1 even when the owner lends the cellular phone 1, precluding the SIM card 14, to each user. As described above, it is possible for the present embodiment to improve security and convenience in sharing services by way of the cellular phone 1 paired with the wireless communication device 2.

The present invention is not necessarily limited to the present embodiment which can be modified in various ways. For example, the present embodiment is designed such that the wireless communication device 2 includes the SIM card 24 which records user identification; but this is not a restriction. It is possible to use other recording media such as a HDD (Hard Disk Drive) and an SSD (Solid State Drive) instead of the SIM card 24. Similarly, it is possible to use other recording media instead of the SIM card 14 in the cellular phone 1.

The present embodiment is designed such that the cellular phone 1 includes the SIM card 14 which records user identification; but this is not a restriction. It is not necessary to install the SIM card 14 in the cellular phone 1. In this case, each user may be allowed to log in the cellular phone 1 by use of the user identification of the SIM card 24 which is automatically transferred from the wireless communication device 2 to the cellular phone 1.

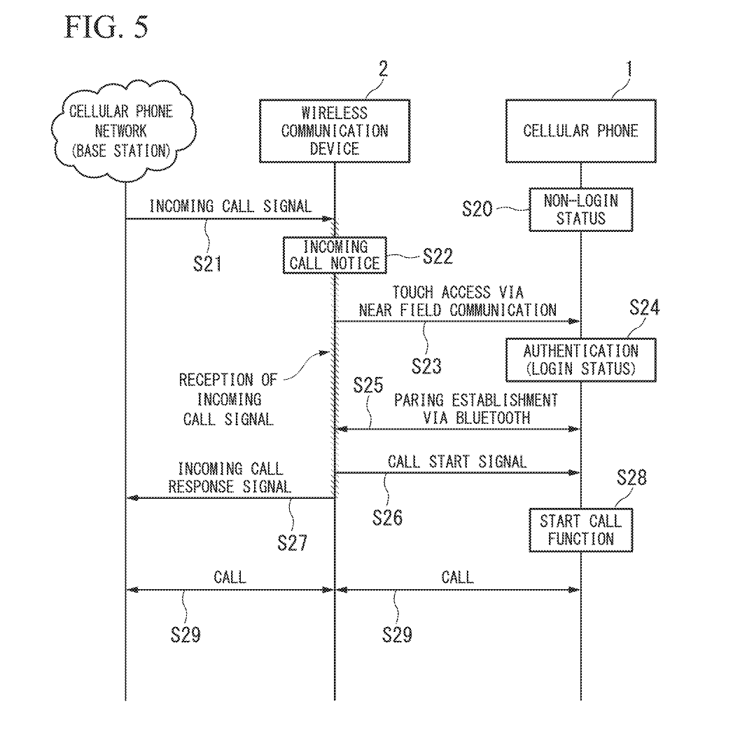

FIG. 5 is a sequence diagram used to explain a second flow of processing exerted between the cellular phone 1 and the wireless communication device 2 in connection with the cellular phone network. Herein, the cellular phone 1 and the wireless communication device 2 are each equipped with a voice communication function, which will be described with reference to FIG. 5.

Initially, the cellular phone 1 is set to the “non-login status” (step S20), wherein an outsider or a stranger makes a call to communicate with one of users sharing the cellular phone 1. At this time, the cellular phone network (e.g. a base station) transmits an incoming call signal to the wireless communication device 2 including the SIM card 24 (step S21).

Upon receiving an incoming call signal via the line communication part 25, the controller 20 of the wireless communication device 2 sends an operation signal to the incoming call notice part 26. Upon receiving the operation signal, the incoming call notice part 26 reproduces an incoming call sound or vibrates the wireless communication device 2 by way of a vibration function, thus sending an incoming call notice to the user of the wireless communication device 2 (step S22). Thus, it is possible for the user to recognize reception of an incoming call signal destined to the user.

Then, the user who recognizes an incoming call makes touch access to the cellular phone 1, which is currently being set to the non-login status, with the wireless communication device which is currently receiving the incoming call (step S23). Upon receiving user identification via the touch access part 11 due to touch access, the controller 10 of the cellular phone 1 (i.e. the login authentication part 100) immediately carries out an authentication process, thereafter, the login status setting part 101 sets the login complete status to the cellular phone 1 (step S24). When the controller 10 successfully authenticate the user so as to set the login complete status to the cellular phone 1, the paring part 12 of the cellular phone 1 and the paring part 22 of the wireless communication device 2 mutually establishes a high-speed wireless communication (i.e. paring) via Bluetooth (step S25).

Next, when the wireless communication device 2 is paired with the cellular phone 1 during reception of an incoming call signal, the controller 20 transmits a call start signal to the cellular phone 1 (step S26). Upon detecting completion of authentication due to touch access and completion of paring by way of steps S23 to S25, the wireless communication device 2 transmits an incoming call response signal to a base station. Herein, the incoming call response signal indicates that each user currently receiving an incoming call responds to the incoming call. Upon receiving the incoming call response signal, the base station allows each user to proceed with voice communication with the other person.

Upon receiving a call start signal via the paring part 12, the call part 13 of the cellular phone 1 starts to execute a call function. Specifically, the controller 10 of the cellular phone 1 receiving the call start signal immediately outputs an operation signal to the call part 13 (e.g. a speaker and a microphone) so as to start executing a call function with the cellular phone 1 (step S28). Thus, the user is allowed to communicate with the other person in connection with the cellular phone network when the call part 13 is activated to start executing the call function (step S29). Herein, the cellular phone 1 may receive or transmit an audio signal via the wireless communication device 2. Alternatively, the cellular phone 1 may directly receive or transmit an audio signal via the line communication part 15.

Upon receiving an incoming call destined to each user, each user is able to recognize reception of the incoming call by way of the wireless communication device 2 assigned to each user. Additionally, each user is allowed to promptly start communicating with the other person on the cellular phone 1 via touch access with the wireless communication device 2. In other words, the present embodiment replaces a user's operation to reply to an incoming call on the phone (e.g. a user's operation of depressing a certain key on the phone) with simple touch access to the cellular phone 1 with the wireless communication device 2. In short, it is possible for the present embodiment to improve convenience of sharing services by simplifying a response operation to an incoming call with the cellular phone 1 paired with the wireless communication device 2.

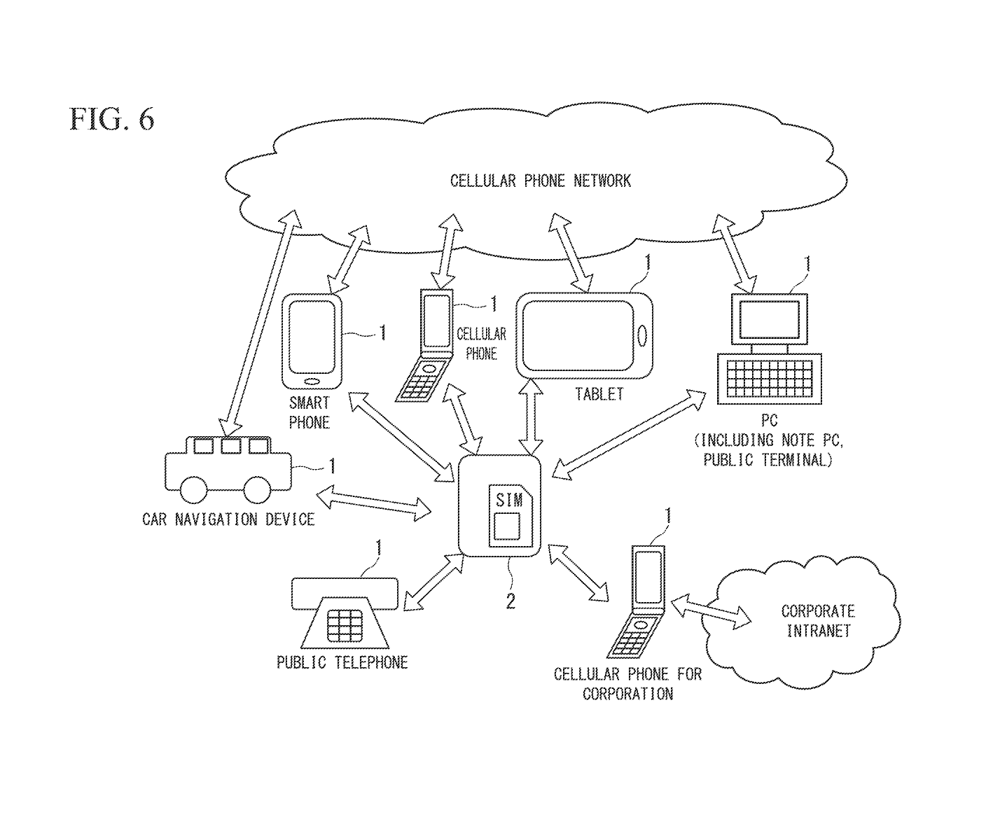

FIG. 6 is a system diagram showing a modified example of the wireless communication system 3 using the cellular phone 1 and the wireless communication device 2. The foregoing embodiment employs a smart phone as the cellular phone 1; but this is not a restriction. As the cellular phone 1, it is possible to employ a variety of devices such as a personal computer, a mobile phone, a public telephone, a tablet-type information processing terminal, and a car navigation device installed in an automobile. Each user may be allowed to use these devices by way of touch access with the wireless communication device 2.

For example, the cellular phone 1 for corporate use may specify an employee via touch access with the wireless communication device 2, thus providing the employee with various types of information reserved in corporate intranets.

In the foregoing embodiment, the wireless communication device 2 is not furnished with any functions except for the incoming call notifying function with the incoming call notice part 26; but this is not a restriction. That is, the wireless communication device 2 may be furnished with the foregoing functions of the cellular phone 1 (e.g. a touch-panel display, a camera, various sensors). Additionally, the wireless communication device 2 including the SIM card 24 may be designed as a card-type device shown in FIG. 3. Alternatively, the wireless communication device 2 may be designed as a wrist-watch device wearable on each user's arm.

The access release key 3 is not necessarily limited to a hardware key shown in FIG. 3. For example, the access release key 23 may be designed as a software key displayed on the screen of a touch-panel display installed in the wireless communication device 2.

Each of the cellular phone 1 and the wireless communication device includes a computer system therein. Herein, the processing executed by each of the cellular phone 1 and the wireless communication device 2 is drafted as programs and stored in computer-readable recording media; hence, a computer reads programs from recording media so as to execute the processing. In this connection, computer-readable recording media refer to magnetic disks, magneto-optical disks, CD-ROM, and semiconductor memory. Alternatively, it is possible to distribute programs to computers via communication lines, thus allowing computers to execute programs.

Lastly, the present invention is not necessarily limited to the foregoing embodiment, which can be further modified in various ways within the scope of the invention as defined in the appended claims.

What is claimed is:

1. A cellular phone comprising:
a touch access part which receives user identification via near field communication;
a login authentication part which specifies a user by way of an authentication process based on the user identification; and
a paring part which establishes a high-speed wireless communication with an external device dedicated to the specified user.

2. The cellular phone according to claim 1, further comprising a login status setting part which sets a login complete status to adopt a system environment unique to the specified user.

3. The cellular phone according to claim 2, wherein the login status setting part receives a logout notice via the paring part so as to terminate the login complete status but to set a non-login status, and
wherein the paring part disconnects the high-speed wireless communication in the non-login status.

4. The cellular phone according to claim 1, further comprising a call part which starts to execute a call function in response to a call start signal which is received via the paring part.

5. A wireless communication device comprising:
a user information recording part which records user identification unique to each user;
a touch access part which transmits the user identification to a cellular phone via near field communication;
a paring part which establishes a high-speed wireless communication with the cellular phone; and
a line communication part which wirelessly communicates with a cellular phone network in connection with the cellular phone.

6. The wireless communication device according to claim 5, wherein the paring part receives data from the cellular phone network via the line communication part so as to transmit data to the cellular phone, and wherein the paring part receives data from the cellular phone so as to transmit data to the cellular phone network via the line communication part.

7. The wireless communication device according to claim 5, wherein the paring part transmits a logout notice to the cellular phone upon detecting an access release key being depressed.

8. The wireless communication device according to claim 5, further comprising an incoming call notice part which notifies each user of reception of an incoming call signal transmitted from the cellular phone network, wherein the paring part establishes the high-speed wireless communication with the cellular phone in response to the incoming call signal, thus transmitting a call start signal to the cellular phone.

9. A wireless communication system comprising:
a cellular phone; and
a wireless communication device,
wherein the cellular phone further includes a first touch access part which receives user identification via near field communication,
a login authentication part which specifies a user by way of an authentication process based on the user identification, and
a first paring part which establishes a high-speed wireless communication with the wireless communication device dedicated to the specified user, and
wherein the wireless communication device further includes a user information recording part which records user identification unique to each user,
a second touch access part which transmits the user identification to the cellular phone via near field communication,
a second paring part which establishes a high-speed wireless communication with the cellular phone, and
a line communication part which wirelessly communicates with a cellular phone network in connection with the cellular phone.

10. wireless communication method comprising:
receiving user identification from an external device via near field communication;
specifying each user by way of an authentication process based on the user identification; and
establishing a high-speed wireless communication with the external device dedicated to the specified user.
